(19) United States
(12) Patent Application Publication
(10) Pub. No.: US 2026/0004111 A1
(43) Pub. Date: Jan. 1, 2026

(54) METHOD FOR GENERATING A TEXTUAL DESCRIPTION OF A DECISION MADE AUTOMATICALLY DURING CONTROLLING OF A ROBOTIC DEVICE

(71) Applicant: Robert Bosch GmbH, Stuttgart (DE)

(72) Inventors: Marcel Hallgarten, Ehningen (DE); Yakov Miron, Tuebingen (DE)

(21) Appl. No.: 19/208,705

(22) Filed: May 15, 2025

(30) Foreign Application Priority Data
May 24, 2024 (DE) 10 2024 204 836.4

(51) Int. Cl. G06N 3/0475; G06F 40/274; G06N 3/042

(52) U.S. Cl. CPC G06N 3/0475; G06F 40/274; G06N 3/042

(57) ABSTRACT

A method for generating a textual description of a decision automatically made during controlling of a robot device is described. The method includes the processing of data containing information about the environment of the robot device by a control processing chain having a plurality of modules, wherein at least some of the modules output a protocol about rule-based intermediate steps performed by the particular module during the controlling, encoding the inputs of at least some of the modules, the outputs of at least some of the modules and the protocols output by at least some of the modules to form a decision process encoding and selecting a textual description for at least one decision made during the processing of the data by the control processing chain from a set of textual descriptions, depending on the decision process encoding.

### FIELD

The present disclosure relates to methods for generating a decision made automatically during controlling of a robot device.

### BACKGROUND INFORMATION

The autonomous controlling of robot devices, in particular autonomous vehicles, typically involves complex processing chains that use machine learning models. A typical problem here is interpretability, i.e., understanding why such a processing chain (in particular a machine learning model) made a certain decision. This is of interest, for example, when it has to be decided whether, if applicable, an autonomous robot device should be reconfigured because it (at least apparently) does not behave as desired, or even behaves incorrectly. Safety can also be increased through such understanding, e.g. by explaining a control decision to a user in advance and allowing the user to override the control decision, if applicable. Accordingly, approaches that provide easily understandable explanations of automatically made decisions in the control of robot devices are desirable.

The paper by Alec Radford et al., “Learning transferable visual models from natural language supervision,” in International conference on machine learning, pages 8748-8763, PMLR, 2021, hereinafter referred to as Reference 1, describes the CLIP method in order to jointly train an image encoder and a text encoder in order to find the correct pairings of images and matching texts in input images and texts.

### SUMMARY

According to various example embodiments of the present invention, a method for generating a textual description of a decision automatically made during controlling of a robot device is provided, comprising the processing of data containing information about the environment of the robot device by a control processing chain having a plurality of modules, wherein at least some of the modules output a protocol about rule-based intermediate steps performed by the particular module during the controlling, encoding the inputs of at least some of the modules, the outputs of at least some of the modules and the protocols output by at least some of the modules to form a decision process encoding and selecting a textual description for at least one decision made during the processing of the data by the control processing chain from a set of textual descriptions, depending on the decision process encoding.

The method of the present invention described above makes it possible to provide informative comments on decisions related to corresponding control actions that an autonomous robot device such as an autonomous vehicle (AV) or an autonomous robot has performed or intends to perform.

This allows a developer or user to understand why the autonomous robot device has chosen the particular control actions. For example, during a test drive of an autonomous vehicle, a developer does not need to guess why a certain action was carried out by the autonomous vehicle. This can contribute to shorter development cycles, as a given test scenario can be repeated with the additional knowledge of why the autonomous vehicle (i.e., a particular controller that selects the control actions) made certain decisions. Such comments are also interesting for the user, as the user can reflect on specific cases during the operation of the system, in which for example an autonomous vehicle made certain decisions. If the user disagrees with these decisions, they are then able to reconfigure the autonomous vehicle so that it does not make these decisions (and avoids resulting undesirable actions). Informing the user in advance about driving decisions can also increase safety, as the user could detect error cases that could lead to potentially safety-critical actions and override the autonomous control in order to instead perform a safe action.

Various exemplary embodiments of the present invention are specified below.

Exemplary embodiment 1 is a method for generating a decision made automatically during controlling of a robot device, as described above.

Exemplary embodiment 2 is the method according to exemplary embodiment 1, comprising selecting the textual description from the set of textual descriptions by evaluating, for each textual description from the set of textual descriptions, a match of a (text) encoding of the textual description with the decision process encoding and selecting the textual description with the best evaluation (e.g., Euclidean distance in the space of the encodings).

This makes the easy generation of comments possible, without the need for a generative model, as predefined comment texts can also be used. An encoder for encoding the textual descriptions of the set of textual descriptions can also be trained together with the processing chain or after its training.

Exemplary embodiment 3 is the method according to exemplary embodiment 1 or 2, comprising generating the textual descriptions of the set of textual descriptions using a generative model (e.g., a large language model (LLM)) that receives an input containing internal states, variable values and/or intermediate results of the control processing chain.

The use (and training) of such a model requires corresponding effort but, with appropriate training, increases the quality and variety of textual descriptions. The input of the generative model can also contain, at least in part, the input and/or output of the processing chain.

Exemplary embodiment 4 is the method according to one of exemplary embodiments 1 to 3, comprising displaying the generated textual description on a display of the robot device.

This explains the decisions made to the user.

Exemplary embodiment 5 is the method according to one of exemplary embodiments 1 to 4, wherein the robot device is an autonomous vehicle controlled in a traffic scene.

In particular in such a context, comments on control actions are important, e.g. for the user (i.e., the driver, who in this case is typically a non-expert) in order to understand the behavior of the vehicle.

Exemplary embodiment 6 is a control device that is configured to perform a method according to one of exemplary embodiments 1 to 5.

The control device can in particular implement the processing chain.

Exemplary embodiment 7 is a computer program comprising commands that, when executed by a processor, cause the processor to perform a method according to one of exemplary embodiments 1 to 5.

Exemplary embodiment 8 is a computer-readable medium storing commands that, when executed by a processor, cause the processor to perform a method according to one of exemplary embodiments 1 to 5.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a vehicle.

FIG. 2 shows a processing chain of modules for controlling a vehicle.

FIG. 3 shows a flowchart illustrating a method for generating a textual description of a decision made automatically during controlling of a robot device according to one example embodiment of the present invention.

### DETAILED DESCRIPTION OF EXAMPLE EMBODIMENTS

The following detailed description relates to the accompanying drawings, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

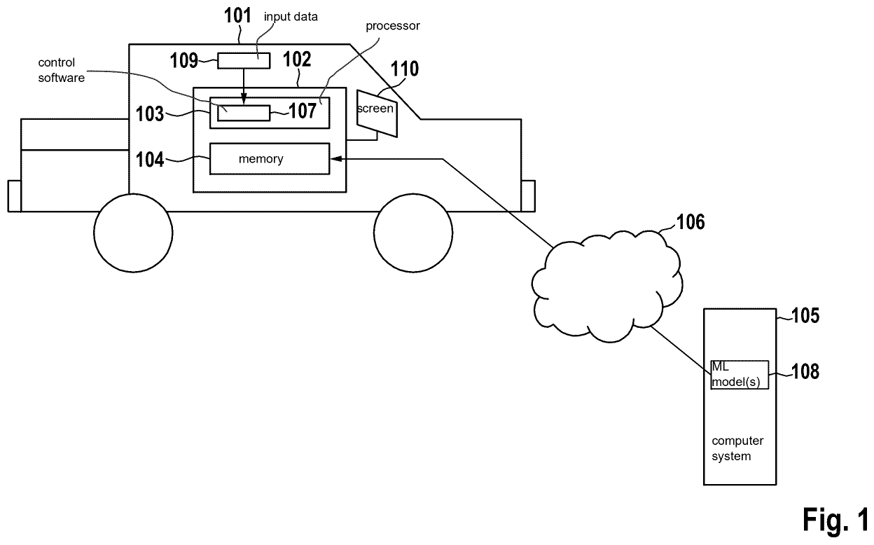

FIG. 1 shows a vehicle 101.

In the example of FIG. 1, a vehicle 101, for example a motor vehicle such as a passenger car or truck, is provided with a vehicle control unit (for example, an electronic control unit (ECU)) 102.

The vehicle control unit 102 comprises data processing components, for example a processor (for example, a CPU (central processing unit)) 103 and a memory 104 for storing control software 107 according to which the vehicle control unit 102 operates, and data that are processed by the processor 103. The processor 103 executes the control software 107.

For example, the stored control software (computer program) comprises instructions that, when executed by the processor, cause the processor 103 to execute driver assistance functions or even to control the vehicle autonomously.

The control software 107 is, for example, transmitted to the vehicle 101 from a computer system 105, for example via a network 106 (or by means of a storage medium such as a memory card). This can also take place in operation (or at least when the vehicle 101 is with the user) since the control software 107 is updated over time to new versions, for example.

The control software 107 can, for example, be trained using machine learning (ML), i.e. the control software 107 implements one or more ML models 108 (or machine learning model), which is trained based on training data, in this example by the computer system 105. The computer system 105 thus implements an ML training algorithm for training the one or more ML model(s) 108.

The control software 107 ascertains control actions for the vehicle (such as steering actions, braking actions, etc.) from input data 109 that are available to it and that contain information about the environment or from which it derives information about the environment (e.g., by detecting other road users, e.g. other vehicles). These are, for example, sensor data such as information obtained from a camera of the vehicle or via communication with other vehicles or devices on the roadside.

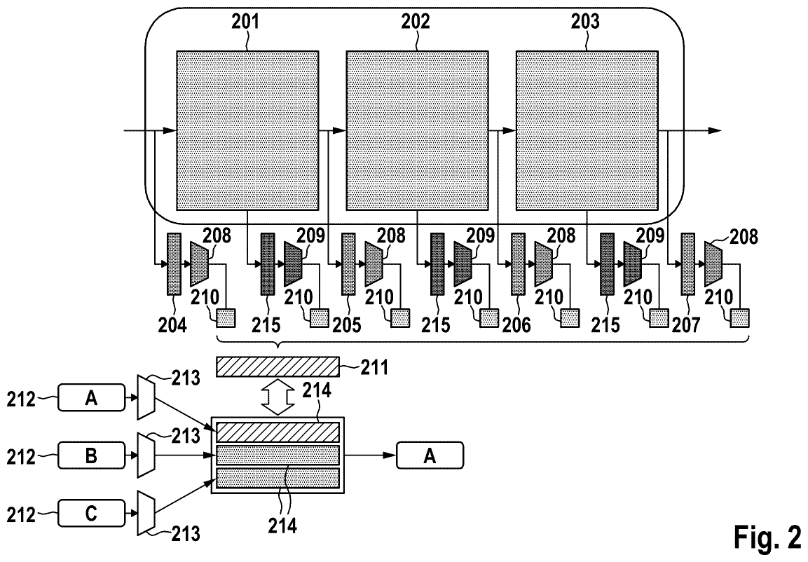

The sensor data (and, if applicable, additional information such as a digital map or information sent to the vehicle by other road users or infrastructure units) are processed by a (control) processing chain in order to control the vehicle, e.g. a modular processing chain, as shown in FIG. 2. The vehicle to be controlled is also referred to in the following as the ego vehicle.

FIG. 2 shows a processing chain of modules 201, 202, 203 for controlling a vehicle.

In this example, the processing chain includes a perception module 201, a prediction module 202 and a planning module 203 (i.e., a chain of modules). These can be realized at least partially by ML (machine learning) models such as neural networks, wherein it is assumed in the following that the processing chain, and thus the resulting driving strategy (or decision strategy in general), has already been trained.

The perception module 201 receives control input data 204 with information about a traffic scene. These are, for example, sensor data (e.g., camera data, lidar data, radar data), map information and/or information received (e.g., via V2X (Vehicle-to-Everything) communication).

The perception module 201 detects the surrounding area of the vehicle, e.g. by localizing the vehicle (or other objects), object detection (e.g., detection of other road users) and object tracking (e.g., of other road users). It provides a perception result 205, for example an object list, an occupancy gate for the surrounding area of the vehicle, etc.

The prediction module 202 makes a prediction for a future state of the surrounding area of the vehicle based on the prediction result, such as future trajectories of other road users. However, it can also ascertain (“predict”) possible behavior of the ego vehicle itself. The prediction module 202 provides a prediction result (e.g., predictions for trajectories (or ranges of trajectories) for other road users).

Depending on the prioritization, the planning module 203 searches for a safe, more comfortable and/or fast trajectory for the ego vehicle based on the prediction result. Its output is a planning result 207, e.g. an ego trajectory in the form of waypoints or the specification of a behavior (e.g., the specification of boundary conditions that must be complied with). These are then translated (if applicable, by a further module) into control actions (braking, steering, etc.). Alternatively, the planning module 203 itself can provide these (low-level) control actions.

The processing chain therefore carries out localization, perception, prediction and planning, e.g.:
Localization and perception with the aim of precisely stating where the ego vehicle is in the environment or providing a reliable model of the 3D environment.
Predicting other vehicles or their intended actions.
Planning the route the ego vehicle should take.

Typically, the ego vehicle (e.g., the vehicle controller 102 implementing the processing chain) makes control decisions according to a particular strategy that provides optimal actions based on the sensing of its surrounding area. According to various embodiments, the explainability and clarity of the actions performed by the vehicle (i.e., its control decisions) is increased by generating and outputting textual comments for the behavior of an autonomous vehicle, e.g. control actions (i.e., justifications for the selection of the control actions).

Ensuring passenger comfort, trust and safety is a key pillar of autonomous driving. Systems that comment on the driving behavior of autonomous vehicles in real time can help achieve this goal. Such systems provide insight into the vehicle's decision-making process and promote a deeper understanding of its operating logic.

According to various embodiments of the present invention, not only the control actions selected by an end-to-end architecture (for machine learning (ML), e.g. a neural network) are described (e.g., a comment text is output for a driving trajectory), but also the decisions made by “classical” (non-ML-based) rule-based components (which perform rule-based intermediate processing steps) are commented on, such as filtering using threshold values or pruning graphs (whose nodes represent different behaviors that are thus removed).

Furthermore, according to various example embodiments of the present invention, comments are generated that can be used by the particular developer (e.g., the control software 107) in order to understand error cases and improve the controlling. This makes shorter development cycles and shorter time-to-market (TTM) possible.

According to various example embodiments of the present invention, the vehicle control device 102 thus generates explanatory comments on the control decisions made by its modular processing chain. The control device generates these comments based on the input 204, the intermediate results (perception result 205 and prediction result 206; the intermediate results are inputs of following modules) and the output (planning result 207) along with protocols (“logs”) 215 which describe the decisions made in rule-based components of the modules 201, 202, 203.

The intermediate results can comprise both interpretable representations such as occupancy grids or object detections as well as latent features (which are passed between modules or sub-modules of the modules described above) (such as the feature map of a camera image extracted from a camera image by an image processing module of the perception module 201, which is then processed by a neural object recognition network).

The input 204, the intermediate results 205, 206 and the output 207 are encoded by first encoders 208 in order to generate extensive descriptive features. Analogously, the protocols are encoded by second encoders (text encoders) 209. The first encoders 208 and the second encoders 209 are implemented, for example, by ML (machine learning) models, e.g. neural networks, which are trained, e.g., together with the processing chain or also afterwards to generate the annotations.

All encodings 210 generated in this way are linked to one another so that a common “decision process encoding” 211 is generated for the decision process in the particular traffic scene (about which information is also contained in the decision process encodings 211) that led to the particular driving decision (i.e., the particular behavior or one or more control actions).

In addition, a series of possible comment texts 212 (e.g., explanations as to why a decision was made) are encoded with a third encoder (text encoder) 213 to form corresponding comment encodings 214 (this can also be done in advance, e.g. in the computer system 105, and the comment encodings 214 can be loaded into the vehicle 100).

The controller 102 compares the common encoding 211 with the comment encodings 214 and selects the comment text whose comment encoding 214 best matches the common encoding 211.

In order to generate correspondingly matching encodings, i.e. to train the encoders 208, 209, 213 such that they generate a common encoding 211 for a specific control decision (i.e., processing through the processing chain) that closely matches the comment encoding 214 of a matching comment, an approach can be used that is similar to one that generates encodings for images that match encodings of matching textual descriptions, such as the approach described in Reference 1.

By comparing the common encoding 211 with each of the comment encodings 214 (e.g., in each case calculating the particular Euclidean distance between the encodings), each of the comment encodings 214 is assigned a point score (or evaluation) that indicates how well the particular comment (text description) fits the decisions of the ego vehicle in the traffic scene. The control device 102 selects the best-matching comment (i.e., the one with the highest score) and outputs it, e.g. on a screen 110 on the dashboard of the vehicle 101. This means that the comment is selected depending on the common encoding (i.e., the decision-making process encoding) 211.

The comment texts 212 can be pre-generated or can also be generated based on internal states and variables of the processing chain and/or the input 204, the intermediate results (perception result 205 and prediction result 206) and the output (planning result 207) and optionally also the protocols (“logs”) 215, for example by a (if applicable, pre-trained) LLM (large language model). For this purpose, these are fed for example to the inner layers of one or more deep neural networks (DNNs) that implement the processing chain and is trained for example to learn a correlation of some parts of the decision strategy with an embedding space of the LLM in order to provide one (or, for the selection, multiple) textual justification(s) for the actions selected by the decision strategy. The purpose is to provide text tokens (text “snippets”) that are rich in nature and provide the user with additional information that would otherwise not have been available.

Overall, the processing chain (which includes the use of one or more trained neural networks) provides, in addition to the planning result 206 (i.e., control actions), textual descriptions that comment on the decisions made during the generation of the planning result 206 (e.g., the selection of control actions or trajectories, etc.). As described above, comment generation can involve a large language model (LLM) that is pre-trained and thus brings in knowledge about the world. The LLM can be trained together with the control strategy (e.g., by training traffic scenes labeled with control actions and comments). In this way, the actions selected by the control strategy become interpretable.

Examples of control decisions and the comments provided for them are as follows:
Steering decision: steer five degrees to the left and accelerate by 1 m/s²
Comment: The reason for steering five degrees to the left is that the predicted curvature of the road is eight degrees, and in order to avoid oversteering, additional attenuation should be applied to the actions. In addition, since a sufficient distance is maintained from the vehicle in front and the speed is below the speed limit that applies here, the vehicle could and should accelerate.
Control decision: braking
Comment: The reason for braking is that the speed of the truck in front is lower than your own speed. Since the other lane is blocked by the oncoming black truck, passing is not possible and an “exit lane” action cannot be performed.
Control decision: drive at 10 km/h
Comment: The vehicle on the right is parked and can be passed. The estimated gap to the oncoming lane is wide enough to fit through. Therefore, driving straight ahead at low speed is the preferred behavior.

Although the exemplary embodiments described above relate to autonomous driving, the approach described herein is also applicable to other areas such as robotics, manufacturing and much more. It can be applied to any application in which a robot device is trained to perform an action in an environment where safety and explainability are required. The term “robot device” can thus be understood to refer to any technical system (comprising a mechanical part whose movement is controlled), such as a computer-controlled machine, a vehicle, a household appliance, a power tool, a manufacturing machine, a personal assistant or an access control system.

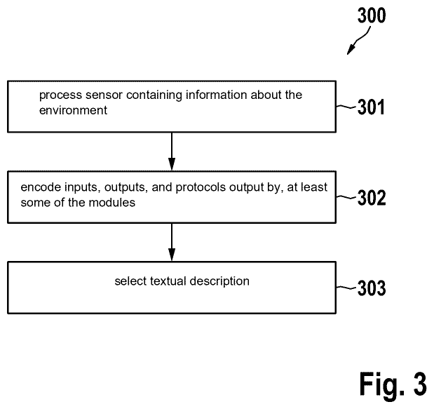

In summary, according to various embodiments, a method is provided as shown in FIG. 3.

FIG. 3 shows a flowchart 300 illustrating a method for generating a textual description of a decision made automatically when controlling a robot device (e.g., an autonomous robot device such as an autonomous vehicle) according to one embodiment.

In 301, data (in particular sensor data) containing information about the environment (or the “surrounding area”) of the robot device is processed by a control processing chain comprising a plurality of (linked) modules (which have a particular input and output). The modules are, for example, (at least) a perception module, a prediction module and a planning module (or sub-modules thereof). In other words, the data are processed by an at least partially modular control pipeline, in which the modules perform different control tasks (i.e., the decision-making process for selecting control actions).

At least some of the modules output a protocol (i.e., a “log”) about rule-based intermediate steps (intermediate decisions) that are made by the particular module during controlling. This includes for example the output of anomalies that occur during this process (i.e., during the rule-based intermediate steps). The rule-based intermediate steps are non-ML (machine learning)-based intermediate steps, i.e. “classical” intermediate steps such as if-then-else operations, safety checks, graph (e.g., tree) operations such as pruning or expanding nodes (the protocol provides e.g. insight into why a node (representing a certain behavior) was removed). The textual description generated for such a graph operation ultimately contains, e.g., “Heavy braking was carried out because node for light braking was removed”).

In 302, the inputs of at least some of the modules (including intermediate results), the outputs of at least some of the modules, and the protocols output by at least some of the modules are encoded to form a (common) decision process encoding. For example, in each case an encoding is generated (for the input, the protocols, each intermediate result and the output) and these (individual) encodings are then combined to form the decision process encoding as described above (e.g., simply concatenated).

In 303, a textual description for at least one decision made during the processing of the data by the control processing chain is selected from a (predefined) set of textual descriptions (from a predefined data set or generated online, e.g. by an LLM), depending on the decision process encoding.

The robot device is controlled, if applicable, according to a processing result (e.g., a planning result as described above) of the processing of the data by the (control) processing chain. However, depending on the textual description, a user can override such (automatic) controlling (e.g., a control action).

According to one embodiment, the encodings are generated by one or more encoders (e.g., implemented by ML models) that are trained together with the processing chain (which can also be at least partially implemented by ML models) or after its training (e.g., using training examples that contain suitable comments as ground truth, or by human feedback for generated comments).

Based on the textual description, a user (or developer) can change the configuration of the processing chain if applicable, e.g. decide whether or not the decision by the processing chain made sense.

The method of FIG. 3 can be performed by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA), or any combination thereof. Any other way of implementing the particular functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

The detection of the particular control situation (or control scene, e.g. the environment of the robot device) can be based on sensor data from various sensors such as video, radar, lidar, ultrasound, motion, thermal imaging, etc.

1-9. (canceled)

10. A method for generating a textual description of a decision made automatically during controlling of a robot device, comprising the following steps:
processing data containing information about an environment of the robot device by a control processing chain having a plurality of modules, wherein each module of at least some of the modules output a protocol of rule-based intermediate steps performed by the module during the controlling;
encoding inputs of at least some of the modules, outputs of at least some of the modules, and the protocols output by at least some of the modules to form a decision process encoding by encoders to generate descriptive features of the decision process in connection with the automatically made decision; and
selecting a textual description for at least one decision made during the processing of the data by the control processing chain from a set of textual descriptions, depending on the decision process encoding.

11. The method according to claim 10, further comprising:
selecting the textual description from the set of textual descriptions by evaluating, for each textual description from the set of textual descriptions, a match of an encoding of the textual description with the decision process encoding, and selecting the textual description with a best evaluation.

12. The method according to claim 10, further comprising:
generating the textual descriptions of the set of textual descriptions using a generative model that receives an input containing internal states and/or variable values and/or intermediate results, of the control processing chain.

13. The method according to claim 10, wherein the encoders are implemented by machine learning models.

14. The method according to claim 10, further comprising:
displaying the generated textual description on a display of the robot device.

15. The method according to claim 10, wherein the robot device is an autonomous vehicle that is controlled in a traffic scene.

16. A control device configured to generate a textual description of a decision made automatically during controlling of a robot device, the control device configured to:
process data containing information about an environment of the robot device by a control processing chain having a plurality of modules, wherein each module of at least some of the modules output a protocol of rule-based intermediate steps performed by the module during the controlling;
encode inputs of at least some of the modules, outputs of at least some of the modules, and the protocols output by at least some of the modules to form a decision process encoding by encoders to generate descriptive features of the decision process in connection with the automatically made decision; and
select a textual description for at least one decision made during the processing of the data by the control processing chain from a set of textual descriptions, depending on the decision process encoding.

17. A non-transitory computer-readable medium which are stored commands generating a textual description of a decision made automatically during controlling of a robot device, the commands, when executed by a processor, causing the processor to perform he following steps:
processing data containing information about an environment of the robot device by a control processing chain having a plurality of modules, wherein each module of at least some of the modules output a protocol of rule-based intermediate steps performed by the module during the controlling;
encoding inputs of at least some of the modules, outputs of at least some of the modules, and the protocols output by at least some of the modules to form a decision process encoding by encoders to generate descriptive features of the decision process in connection with the automatically made decision; and
selecting a textual description for at least one decision made during the processing of the data by the control processing chain from a set of textual descriptions, depending on the decision process encoding.
